(19) United States
(12) Patent Application Publication
(10) Pub. No.: US 2016/0316280 A1
(43) Pub. Date: Oct. 27, 2016

(54) Video Delivery Platform

(71) Applicant: Stinkdigital Ltd., London (GB)

(72) Inventors: Philip Bulley, London (GB); James Britton, Surrey (GB); Mark Pytlik, Brooklyn, NY (US)

(73) Assignee: Stinkdigital Ltd., London (GB)

(21) Appl. No.: 15/135,068

(22) Filed: Apr. 21, 2016

Related U.S. Application Data
(60) Provisional application No. 62/150,539, filed on Apr. 21, 2015.

(51) Int. Cl. H04N 21/8549; H04N 21/472; H04N 21/8547; H04N 21/25; H04N 21/81; H04N 21/2668

(52) U.S. Cl. CPC H04N 21/8549; H04N 21/812; H04N 21/2668; H04N 21/8547; H04N 21/251; H04N 21/47202

(57) ABSTRACT

A video delivery platform allows an editor to create, and a user to select, from among two or more different durations of a single video. The video delivery platform can include a backend component, which is administration and content creation software running on a server or a cluster of servers (locally or remotely). Using the administration and content creation software, an editor or an algorithm prioritizes segments of the video in order to create two or more different durations of the same video. The video delivery platform can also include frontend player software which deployed across multiple device platforms for the end-user to consume the content. The user can indicate which of the two or more different durations of the same video they want to view using the frontend player.

### CROSS REFERENCE TO RELATED APPLICATION

The present application relates and claims priority to U.S. Provisional Application, Ser. No. 62/150,539, filed Apr. 21, 2015, the entirety of which is hereby incorporated by reference.

### FIELD OF THE INVENTION

The present invention relates to a video delivery platform, and, more specifically, to a video delivery platform that adapts the length of the content based on direct user feedback and/or algorithm analysis.

### BACKGROUND

Video content is typically delivered to the user by one or more scrollable lists containing a thumbnail, title, and/or textual description of the content of the video. When a user selects a video, it is presented as a single duration in time and is consumed via a linear delivery mechanism. For example, for an individual piece of content, a ‘one-duration-fits-all’ approach is applied to every user regardless of their context. However, the ‘one-duration-fits-all’ approach is not an effective delivery mechanism. Studies suggest that when users are presented with a video that is approximately five minutes long, at least 20% abandon the video after only 10 seconds, 44% have abandoned the video after one minute, and nearly 60% have abandoned the video after two minutes.

Using some video platforms, the user can ‘fast forward’ or scan the linear timeline of the video in search of important segments, or segments that will interest them. In a best-case scenario, the user's fast-forward attempt is facilitated by thumbnail imagery that provides clues to the location of content within the timeline of the video. This is especially helpful if the user is already familiar with the video's content. However, if the user is not familiar with the video, this fast-forward or scanning is highly inefficient because the thumbnail previews fail to provide accurate context or information about the relevance of segments.

Video content advertising is often monetized with advertising that appears before the selected video is played. Long advertisements that appear before the video is played often results in frustration by users who are eager to watch the video but must endure the advertisement. The longer the advertisement, the greater the frustration. Indeed, studies suggest that when presented with the ability to skip a pre-roll advertisement, users will skip the advertisement approximately 80-85% of the time.

Accordingly, there is a continued need in the art for a video delivery method and service that abandons the ‘one-duration-fits-all’ approach and adapts the length of the content based on direct user feedback and/or algorithm analysis.

### BRIEF SUMMARY OF THE INVENTION

Systems and methods for a video delivery platform. The video delivery platform allows an editor to create, and a user to select, from among two or more different durations of a single video. The video delivery platform can include a backend component, which is administration and content creation software running on a server or a cluster of servers (locally or remotely). Using the administration and content creation software, an editor or an algorithm prioritizes segments of the video in order to create two or more different durations of the same video. The video delivery platform can also include frontend player software which deployed across multiple device platforms for the end-user to consume the content. The user can indicate which of the two or more different durations of the same video they want to view using the frontend player.

In one aspect, a system is provided for creating and delivering a customized video based upon a video stock of predetermined duration. The system generally comprises: (1) a server computer having a first computer processor; (2) a back-end computer program product for use by an administrator to create the customized video, the back-end computer program product comprising computer readable storage medium having program instructions embodied therewith, the program instructions executable by the first computer processor to cause the computer processor to prioritize at least two distinct segments from the video stock in order to create at least two different durations of the video stock each of which is shorter in duration than the predetermined duration; (3) at least one end user device having a second computer processor and in operative communication with the server computer; and (4) a front-end computer program product for use by an end user to consume the customized video, the front-end computer program product comprising computer readable storage medium having program instructions embodied therewith, the program instructions executable by the second computer processor to cause the device to permit the end user to select which of the at least two distinct video segments to execute on the device.

In another aspect, a computer program product is provided for use by an administrator to create customized video from a stock video of predetermined duration, the computer program product comprising computer readable storage medium having program instructions embodied therewith, the program instructions executable by a computer processor to cause the computer processor to: (1) assign a first priority to at least one distinct segment from the video stock in order to create at least one first priority segment of at least one different duration of the video stock which is shorter in duration than the predetermined duration; (2) assign a second priority to at least one distinct segment from the video stock in order to create at least one second priority segment of at least one different duration of the video stock which is shorter in duration than the predetermined duration; and (3) arrange the customized video such that each of the first priority segments is played prior to the second priority segments.

In another aspect, a method is provided for creating customized video from a stock video of predetermined duration. The method generally comprises the steps of: (1) assigning a first priority to at least one distinct segment from the video stock in order to create at least one first priority segment of at least one different duration of the video stock which is shorter in duration than the predetermined duration; (2) assigning a second priority to at least one distinct segment from the video stock in order to create at least one second priority segment of at least one different duration of the video stock which is shorter in duration than the predetermined duration; and (3) arranging the customized video such that each of the first priority segments is played prior to the second priority segments.

In another aspect, a computer program product is provided for use on a device having a computer processer by an end user to consume a customized video created from a stock video of first predetermined duration. The computer program product comprises computer readable storage medium having program instructions embodied therewith, the program instructions executable by the computer processor to cause the device to: (1) provide a user interface that permits the end user to select from a plurality of options for viewing the customized video, wherein the plurality of options comprises customized video segments each of which is at least a portion of the customized video and of a respective second predetermined duration that is no longer than the first predetermined duration; and (2) display the end user selected video segment.

### DESCRIPTION OF THE SEVERAL VIEWS OF THE DRAWINGS

The present invention will be more fully understood and appreciated by reading the following Detailed Description in conjunction with the accompanying drawings, in which:

FIGS. 1A-1C are schematic representations of video timeline segment prioritization by an editor in accordance with an embodiment.

FIGS. 2A and 2B are schematic representations of video presentation in accordance with an embodiment.

FIGS. 3A and 3B are schematic representations of video presentation and duration selection in accordance with an embodiment.

FIG. 4 is a schematic of video timeline transitions in accordance with an embodiment.

FIGS. 5A-5C are schematics of video timeline segment prioritization in accordance with an embodiment.

FIGS. 6A-6F are schematics of video timeline segment prioritization in accordance with an embodiment.

FIGS. 7A-7C are schematics of video timeline segment prioritization in accordance with an embodiment.

FIG. 8 is a schematic representation of video presentation and duration selection in accordance with an embodiment.

FIG. 9 is a schematic representation of video presentation and duration selection in accordance with an embodiment.

FIG. 10 is a schematic representation of video presentation and duration selection in accordance with an embodiment.

FIG. 11 is a schematic representation of video presentation and timeline selection in accordance with an embodiment.

### DETAILED DESCRIPTION

The disclosure is directed to a video delivery platform. According to an embodiment, the video delivery platform allows an editor to designate, and a user to employ, a system for adjusting the duration of a single video. The platform may be deployed as a ‘Platform as a Service’ (PaaS) or as a platform installable to a custom public or private environment.

According to an embodiment, the video delivery platform comprises a backend component, which is administration and content creation software running on a server or a cluster of servers (locally or remotely). Using the administration and content creation software, an editor or an algorithm prioritizes segments of the video in order to create two or more different durations of the same video. The video delivery platform also comprises frontend player software which deployed across multiple device platforms for the end-user to consume the content. According to an embodiment, the user can indicate which of the two or more different durations of the same video they want to view using the frontend player.

1. Backend Video Editor

According to an embodiment, the system includes an administration and/or content creation and editing component, which may be referred to as a ‘Backend Video Editor.’ The content creation and editing component may be hosted on a server or a cluster of servers, either locally or remotely. For example, an editor with access to the backend video administration and/or content creation and editing component can access it through a webpage or some other online portal or access point. Alternatively, the editor can access the component using local software and/or hardware which can communicate the changes and/or final product to a remote server for processing and delivery to the end-user.

The backend video administration and/or content creation and editing component can comprise a suite of tools that allow the video editor to modify the length of the video. For example, the suite can enable the video editor to tag individual sub-segments of video by importance and/or relevance to one or more individuals, times, locations, or other content cues. The platform can then render multiple video edits, each containing different groups of sub-segments relating to their editorial hierarchy.

Video Organization

According to an embodiment, the system includes multiple “Episodes,” or videos. Each Episode, or video, consists of multiple “Timeframes” (a Timeframe is an edit of the Episode with a specific duration, see below). An Episode may be conceptually linked to other episodes via tags, links, contextual clues, or other mechanisms. Advertising, for example, may be associated with certain Episodes.

The system may also include “Channels” of content, which is a grouping of Episodes focused around a specific concept such as fashion (which could be administrator-generated), international news (which could be administrator-generated), watch later (which could be user-generated), popular (which could be dynamically-generated), and many, many more. Episodes may be linked to one or more Channels. This means the Channel has the option of scheduling the Episode based on its scheduling rules. For example, if the Episode has a parent Season and Show, its sibling or related Episodes may also be displayed within the context of the Channel. Multiple Channels may appear within a Content Network, and a single Channel may be assigned to multiple Content Networks. Channels can schedule Episodes assigned to them based on the Channel's scheduling rules. Channels may schedule Episodes based on: manual playlist indexing, and/or dynamic playlist generation based on a combination of tags (match one, match all, exclude) or sort fields (date added, alphabetical, etc. . . . in ascending/descending order), among other options.

The system can also include multiple sequential Episodes connected or linked to each other by tags, links, contextual clues, or other mechanisms into a “Season.” Typically, an Episode may be sequentially linked to other Episodes via a Season. An Episode may appear in no more than one Season, and an Episode may appear no more than once within a single Season. A Season typically has an ordering rule for displaying Episodes (manual indexing, sort on Episode fields, etc. . . . ).

In addition to these organizational formats, many other organizational formats and/or hierarchies are possible.

Advertising Content

According to an embodiment, the system can present advertising to the user in a wide variety of formats. For example, a standard advertisement may be a linear video advertisement that has not been Timeframe-enhanced. It may be a simple standalone video or controlled via an advertisement server using a custom or specific protocol specification. Alternatively, the advertisement may be an enhanced advertisement with two or more Timeframes that the user can switch between while viewing the content. In terms of end-user experience, an enhanced advertisement can function in a similar fashion to an Episode.

Segment Prioritization

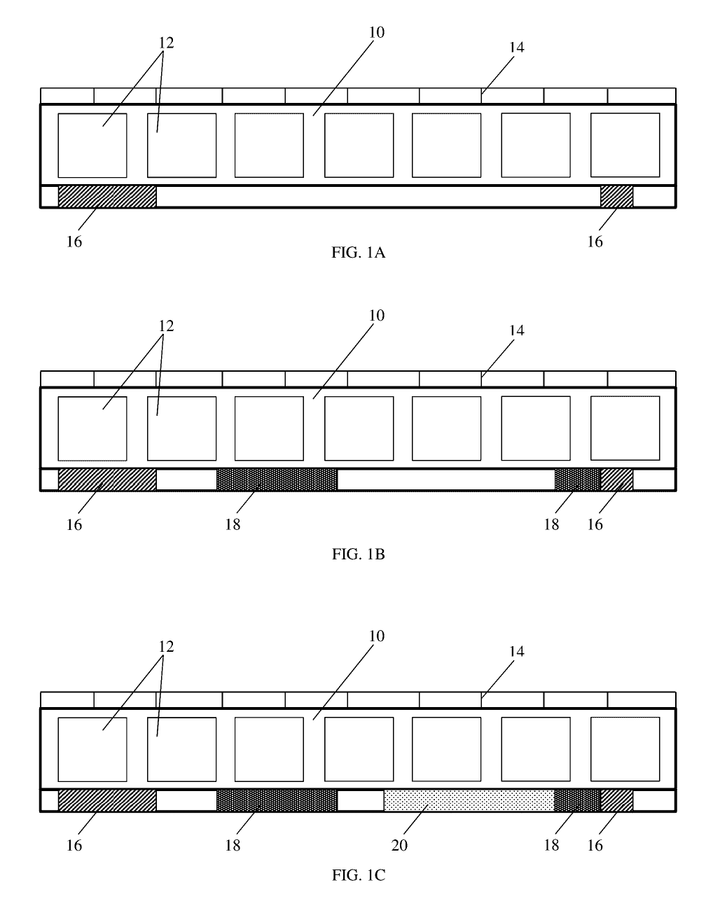

According to an embodiment, the administration and/or content creation and editing component allows an editor to assign priority or relevance to segments of a video timeline in a process called Segment Prioritization. Referring to FIG. 1A, for example, is a video timeline 10 for a particular video with a series of frames 12. The editor views the timeline through the administration and/or content creation and editing component, such as through a webpage, online portal, or local software display. As an initial step, the editor assigns the highest priority and/or relevance designation 16 to segments or frames of the video that the editor understands, believes, or predicts to be of upmost importance. In other words, if the end-user is only able to view the minimum amount of a video, these segments receiving the highest priority and/or relevance designation 16 will be shown to the user.

As shown in FIG. 1B, the editor can then assign the second-highest priority and/or relevance designation 18 to segments or frames of the video timeline that the editor understands, believes, or predicts to be of sufficient importance and/or relevance. In other words, if the end-user is able to view an amount of a video greater than the minimum but not yet the maximum, these segments receiving the highest priority and/or relevance designation 18 will be shown to the user.

As shown in FIG. 1C, the editor can then assign the third-highest priority and/or relevance designation 20 to segments or frames of the video timeline that the editor understands, believes, or predicts to be of sufficient importance and/or relevance. In other words, if the end-user is able to view an amount of a video still greater, these segments receiving the highest priority and/or relevance designation 20 will be shown to the user. The designation process can occur until all segments of the video timeline are selected.

According to yet another embodiment, the system can automatically suggest and/or designate segments. As an example, the assignment of priority or relevance to one or more segments or frames of a video is performed using a predictive algorithm. For example, the software may learn from the editor processing previous videos. The algorithm could then predict how the editor would assign priority or relevance to one or more segments or frames of a current video based on similarities or other contextual relationships between the previous videos and the current video. This will require an algorithm capable of analyzing editor actions and learning from the analysis.

According to an embodiment, a “Timeframe” is an edit of a video with a specific duration. A single Timeframe containing the full duration of the video is the minimum requirement for any video (analogous to no timeframe change functionality, as only the full video is available for playback), while multiple Timeframes can represent smaller sub-durations of the full content. The availability of multiple Timeframes allows users to select the duration within which they wish to view the video's content. There is no limit to the number of Timeframes within a video, and the number used within any single video will be down to the preferences of the administrator/editor and the length content being presented.

For example, a typical pattern for short-form content (approximately 2-10 minutes total duration) may be to use four timeframes (e.g., a ‘four Timeframe configuration’):
1. SMALL (approximation 10 second duration);
2. MEDIUM (approximately 30-40 second duration);
3. LARGE (half of the full duration); and
4. FULL (full duration).

The administrator/editor may prefer to offer additional Timeframes, such as in the case of longer-form content. In that case, the administrator/editor may specify the creation of a Timeframe every n seconds. As an example, if the administrator/editor sets the value of n to 20 seconds, the player will attempt to create Timeframes as close to every 20 seconds as possible. This would allow the end-user to tailor the duration of the video, at runtime, by increments of approximately 20 seconds.

The administrator/editor may configure the user interface to represent Timeframes using custom text label descriptions, a numeric time description of the duration, a visual scale depicting how timeframes are relative to one another, or any other visual device which may allow users to control the duration of the video.

Transitions

When using a “Simple Transition” (discussed in greater detail below), the time ranges can be grouped based on their given priority and sorted by timecode (in a similar fashion to the front-end process of Dynamic Allocation Transitions, but in this case, on the back-end). The frames of video represented by the time ranges are concatenated, resulting in a single render output per Timeframe. When using a “Dynamic Allocation Transition” (discussed in greater detail below), time ranges can be rendered out as individual video files, ready for the front-end player to consume at will.

Adding Timeframe-Enabled Content to the Platform

According to an embodiment, video footage is uploaded to the platform by an administrator with access to the Content Network. Uploaded footage becomes the building blocks of an Episode and is used as the primary source of content to create all the elements within an Episode, including its timeframes. The administrator then has the option to enable the timeframe segments in two ways. If the video footage has been pre-rendered, it can be uploaded directly into a Simple Transition timeframe slot, for example. When employing a four Timeframe configuration, up to four pre-rendered video files can be uploaded into a single Episode, each occupying one of the “S”, “M”, “L” or “FULL” timeframes.

Annotation

Episodes and Timeframe elements can optionally be annotated with information that helps to describe the content. Annotations will then be used either by the platform itself (to trigger routines for smart selections of content to be broadcast) or users to navigate through content offered by the frontend.

According to an embodiment, there are two main forms of annotations. “Chapters” are defined with a title, a description and an anchor point to a timeframe element. These can be used by the frontend to give users a quick way of jumping to different sections within a single timeframe. “Tags” are defined with a taxonomy (or vocabulary), a text field and optionally a relation to a parent tag that would define a hierarchy or specialization. Tags are mainly used to activate dynamic content broadcast for channels where this service is available.

Content Network and channels

A content network is a set of channels grouped in a single logical container. A channel can belong to multiple content networks. Channels are the main access point for content: these are most likely to be embedded on web pages, in native applications or any other means of device deployment via the appropriate front-end renderer.

Content broadcast by a channel can be defined by administrators via a combination of two methods: “Statically”—uploading content, defining timeframes and grouping episodes within a single channel, or “dynamically”—defining which annotations should be used to populate a channel, these will then trigger specific functions used by the recommendation engine for content selection.

Recommendation Engine and User Context Cues

According to an embodiment, the system includes a recommendation engine that utilizes user context cues to provide the system with information about what video, and/or what version or length of video, to provide to a user.

For example, user context cues could be provided by the user directly, or could be gathered or inferred by one or more components of the system. As an example, the user may indicate by clicking, touching, or otherwise selecting a particular type, genre, or class of video. The system will then prioritize that type, genre, or class of video when providing a list and/or video to the user. Alternatively, the system may determine that the user prefers a certain type, genre, or class of video based on prior selection of video, in which case the system will necessarily comprise a database or other reference system for storing information about which videos or video types the user has selected in the past.

As another example, the system may determine the specific date, day of the week, month, and/or time, and allow the user to select specific videos based on that determined date and/or time. Alternatively, the system may determine that the user prefers a certain type, genre, or class of video at that specific date and/or time based on prior selections of video by the user at that specific date, day of the week, month, and/or time. As an example, the user may prefer to watch longer video content on Friday evenings while preferring to watch short, newsworthy videos between the hours of 5 AM and 8 AM during the week.

As another example, the system may determine that the user has only a short period of time to consume content. This can be accomplished by asking the user how much time they have to consume content, such as through a prompt, button, or other selection mechanism. For example, when the user opens or access the video content, the system can prompt the user with “how long are you free?” or “what is your preference” along with selections like “1 minute,” “5 minutes,” “1 hour,” or many other time durations. Based on the selection by the user, the system will provide information to the recommendation engine or other component of the system responsible for selecting or directing the selection of content for the user. Alternatively, the system may determine that the user almost always consumes content in 1 minute increments, or almost always consumes content in 4 minute increments at certain times, locations, or days. According to this embodiment, therefore, the system will necessarily comprise a database or other reference system for storing information about which videos or video types the user has selected in the past on certain dates, days of the week, at certain times, and/or certain locations.

According to an embodiment, Channels serving dynamic content are supported by the recommendation engine, which is capable of feeding the stream with episodes as well as suggesting a relevant initial timeframe. The sequence of content is generated according to one or more of the rules. For example, the content sequence can be generated by tags belonging to related context. Defining how tags are related is the responsibility of a combination of several techniques, including but not limited to: results provided by an ontology reasoner using tags' taxonomies as input, rules of tags proximity defined by NLP techniques, taxonomy graph walking. As another example are functional tags (or machine tags), which are generally tags capable of evaluating functions at runtime and provide results based on quantities, these can include (but not limited to): number of views or frequency over a given period, set of tags defined with temporal relationships between each other, content referring to or published within temporal ranges. As a third example is the factorization of adjacency matrices based on user profiling functions and content available on the platform, it is possible to factorize a (U×C) matrix—with U vector of users and C vector of content with respective timeframes—the resultant being a vector of timeframes likely to fit user's preferences.

The Recommendation Engine isn't limited to providing feedback aimed at the end-user. It is also used to power content strategy recommendations aimed at administrators. Administrators can access player metrics and reporting aided by digestible insights as generated by the recommendation engine's analysis of those metrics. Insights may be displayed within the Analytics suite or appear inline at the time of content creation/editing. An example of such an insight may be (but certainly not limited to) “Comedy content is best received by your viewers when released on a Friday, shall we reschedule Episode releases of this Show to Fridays?”. The Channel administrator may react by configuring answers in response to these questions, or they may preconfigure the platform to take action without human input, providing a level of automated content optimization.

2. Video Player

According to an embodiment the system includes a video player, which may be referred to as the platform frontend, which is configured or programmed to play the video created with the Backend Video Editor. The video player can be deployed at a single location, or can be deployed across multiple device platforms which will allow end-users to consume content.

For example, consumers or end-users of video content according to the system can have access to the video player through a web browser and consume a channel or other digestible presentation of video content embedded in a web page. Active browsing and content consumption tools can be provided by a set of interactive elements embedded in the player. All content broadcast by a channel can be prepared by administrative users with access to the Backend Video Editor, for example. The web interface can be the main access point at which content editing and channel management is handled, as well as settings and algorithms that drive automated broadcasting functions.

According to an embodiment the video player displays videos in the form of full or segmented video, and can display anything that is renderable, such as advertisements. The video player can, for example, include a “Stream,” which is a view which includes a collection of videos (such as a single frame, animation, or other display) that can be navigated through. The Stream and/or videos in the Stream may animate on a directional axis during navigational transitions, for example. The system may also include a “Stream Overview,” which is an expanded view of a Stream where multiple screens are simultaneously visible in the single display. This allows relatively quick navigation and manipulation of the Stream as a whole by the user. In this view, a screen may contain video content, summarized video content, animated/static thumbnails and/or text.

Screens

As described above, Channels can be presented in the form of a continuous Stream of content (usually Episodes). Individual Episodes can appear within/on separate video Screens that can animate on a directional axis during a Screen transition.

According to an embodiment, a Screen transition can be initiated and controlled by the player (e.g., a cue point, video time event, or similar) or by user interaction (e.g., a click, drag, flick, swipe or any other action signaling an intent to navigate, among others). During a transition, the player will attempt to have both the outgoing and incoming video content playing. As such, a player-initiated transition may begin a short time before the outgoing video has completed playback.

Regardless of whether a transition is player- or user-controlled, an audio crossfade based on the transition's progress will dictate how the sound from the two playing videos is mixed into a single output. This results in an audio transition that is directly related to the state of visual transition of screens/content.

According to an embodiment, internally the player uses three screens only. As the Channel Stream is navigated through, a controller will instruct each Screen with the nature of content to display. This may be a Timeframe-enabled Episode, an advertisement loaded in from an Ad Server, or any other renderable content/UI. The effect of a continuous stream of Screens (looping or endless) is created by swapping content in and out of Screens and instantly altering Screen positions at the appropriate times.

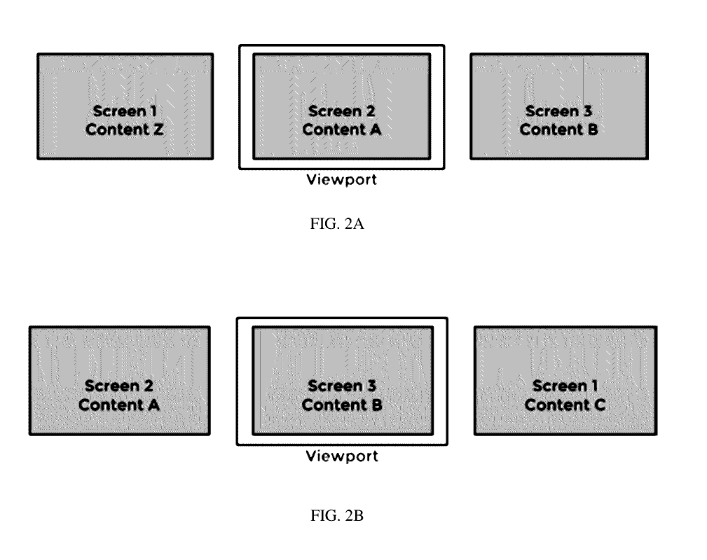

Referring to FIG. 2A, for example, is an example of possible starting positions for the player. As the user navigates through the Stream, in this example and as shown in FIG. 2B, the screens are repositioned along the X-axis. Many other configurations and repositions are possible, including but not limited to the Y-axis, diagonally, and others.

Timeframe Transitions

When displaying video content, in addition to standard video controls (ie. play, pause, rewind, fast-forward, etc) additional controls may also be displayed (as determined by the player and/or server-side software), allowing the user to control the duration of the content. The controls allow iteration over options/steps where each is known individually as a Timeframe, whilst collectively the controls are known as the Timeframe UI Controls.

There are no constraints on how these controls are to appear visually. Examples of controls may include but are not limited to: (i) increase and decrease duration controls which allow iteration over Timeframes; (ii) custom textual/numeric/graphical label descriptions per-Timeframe; (iii) a visual scale depicting how timeframes are relative to one another; and/or (iv) any other visual device which may allow users to alter the duration of the Episode before, during or after playback.

Episodes with Timeframe functionality will automatically begin playback with a single default Timeframe preselected. This will be determined by either player logic or recommendation engine logic originating from the server-based software. Without any user interaction, this results in a pre-determined duration of video content playing before moving on to the next Episode within the Channel. However, the user may at any time interact (via click, touch, drag, swipe, voice command, or any other interaction gesture) with any non-selected Timeframe, thus signaling their intent to increase or decrease the duration of the content they are currently watching. This action triggers a specific logical flow which will determine how the player handles the transition from the current (departure) Timeframe to the newly selected (destination).

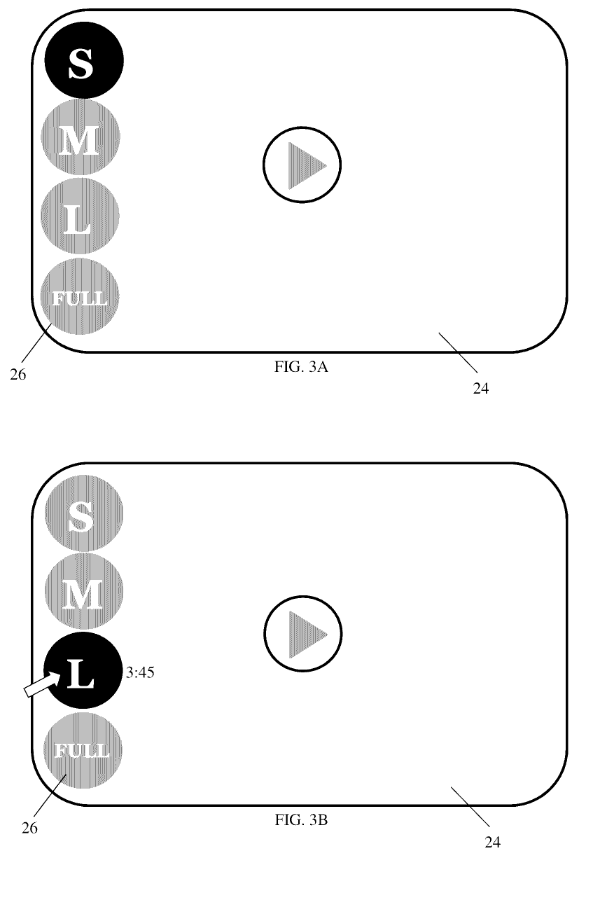

Shown in FIGS. 3A and 3B is a playback screen or window 24 with Timeframe UI Controls 26. In FIG. 3A, the user has not yet selected any Timeframe, and the default Timeframe will automatically proceed. In this example, the default is the shortest duration, although it may default to any of the durations. The Timeframe UI Controls 26 include several selections, including S for Short, M for Medium, L for Long, and FULL for the full duration. The length of each Timeframe gets progressively, although not necessarily exactly by the same increment, longer from S to FULL. In FIG. 3B, the user has selected L for the Long Timeframe, and optionally the duration of that Timeframe (here, 3 minutes and 45 seconds) is displayed to the user. According to an embodiment, the length of each Timeframe may appear as the user hovers over or clicks on each Timeframe UI Control 26.

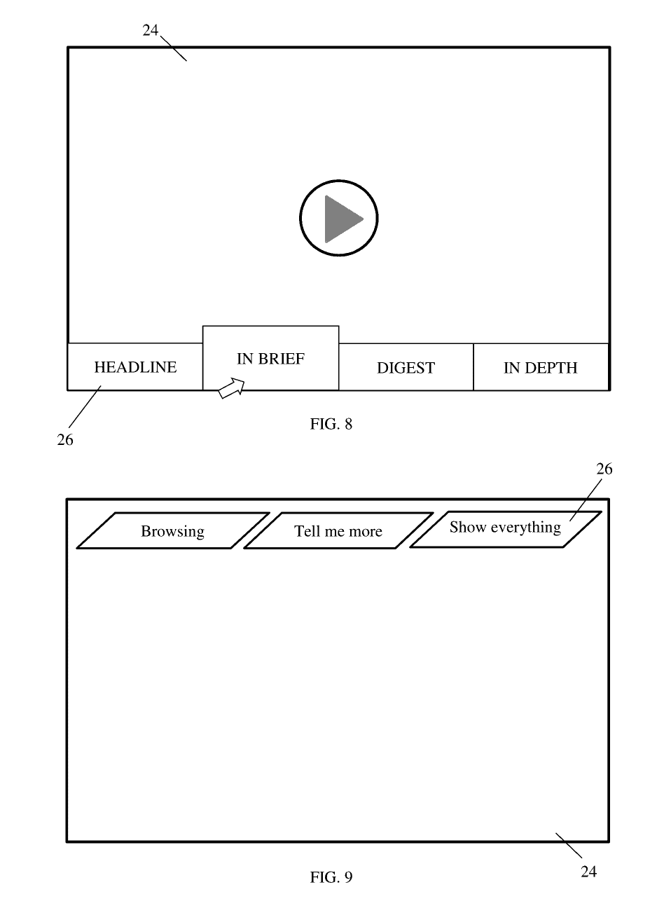

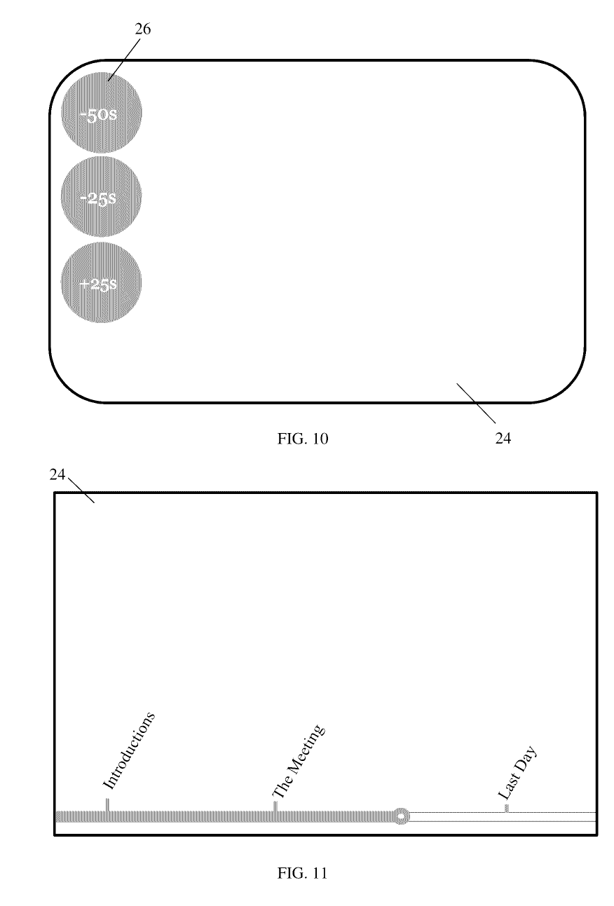

FIGS. 8-10 demonstrate a variety of different user interfaces with customizable Timeframe indicators/selectors. The User Interface of the viewer/player can be skinned to reflect the client's brand, and is thus highly customizable and designable. For example, the different durations can be indicated by different words, symbols, letters, or numbers. Thus the Timeframe buttons 26 can communicate length options to the user in a wide variety of mechanisms. In FIG. 8, for example, the user interface uses words to indicate length. In FIG. 9, for example, the user interface uses wording that appeals to the user's level of interest in the subject matter. In FIG. 10, for example, the Timeframe buttons indicate how much time will be added or subtracted from the current duration. In another embodiment, the user interface could include a scale or slider that allows duration selection. Moving the scale or slider clockwise could increase duration, while counter-clockwise would decrease duration. The slider might snap to the timeframe duration increments along the path, for example.

In addition to Timeframe duration, the user interface can also convey information about the content or context of segments to the user via annotation. The annotation can be presented to the user in the form of timeline navigation, for example, which would simulate the effect of chapters, as shown in FIG. 11. This might be coupled with thumbnails to allow the user to navigate through the video with increased information and confidence.

Transitions

According to an embodiment, there are two methods of transition. The first, “Simple Transition”, is employed when the Channel administrator/editor believes that a simple iconic approach to defining a limited set of Timeframes suits their type of content best. The second, “Dynamic Allocation Transition”, allows for finer-grained end-user adjustment of duration as many more Timeframes may be generated for the user to iterate over. The following is a detailed specification of how each of these methods function.

Simple Transitions

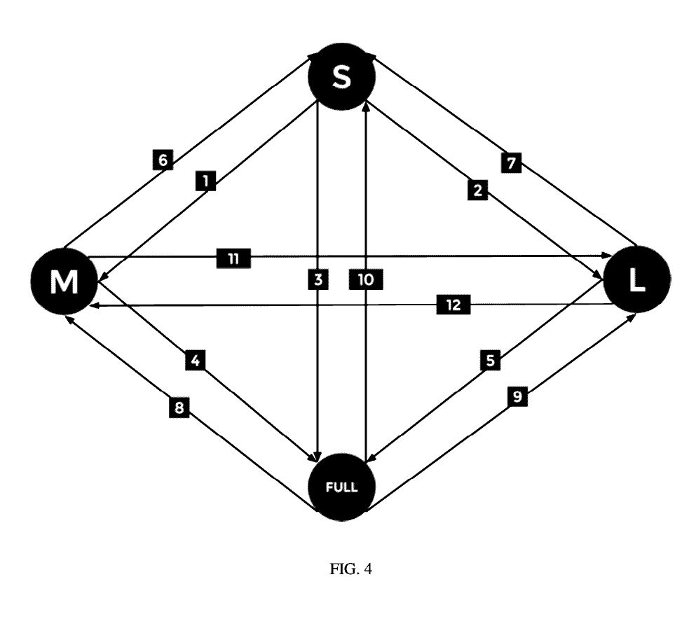

In a ‘four Timeframe configuration’, such as that shown in FIG. 4 (with Short (S), Medium (M), Long (L), and Full (FULL) Timeframes), there are a total of 12 possible transitions where the grouped departure and destinations are unique (outlined in the diagram below, labeled 1 to 12). Each transition can be represented by one of three ‘types’ of transition, where a type is characterized by a functional subroutine irrespective of variable values relating to the associated Timeframes. A transition type determines how the video buffer is emptied and refilled during the transition, hence affecting how content is presented on the screen. The types of transition are labelled as “Type X”, “Type Y” and “Type Z”.

The general rules in determining which transitions apply are as follows. For Type X, transitions apply when moving from S to one of the additional timeframes below FULL. For Type Y, transitions apply when moving from one of the additional timeframes back down to S. For Type Z, transitions apply when moving between additional transitions.

Type X, or transition 1 in FIG. 4, is for example from S to M. According to an embodiment, S continues to play until the point where more buffer is required in which case the first segment of M is appended and then M continues to play from there. For transition 2 in FIG. 4, from S to L, S continues to play until the point where more buffer is required in which case the first segment of L is appended and then L continues to play from there.

Type Y or transition 3, 4, or 5 in FIG. 4, is for example from S, M, or L to FULL. The system cuts at the current position, and it empties the entire buffer at which point it appends the first segment of FULL, and FULL will then continue to play. For transition 6 (M to S), 7 (L to S), or 10 (FULL to S) in FIG. 4, for example, the system cuts at the current position, and it empties the entire buffer at which point it appends the first segment of S, and S will then continue to play.

Type Z for transition 8 (FULL to M) or 12 (L to M) is more complicated and utilizes the following general format:

1. IF previous transition was Type Z AND S is NOT fully watched
a. Update flag specifying that M should follow S
b. GOTO 5c
c. END

2. ELSE cut at current position

3. Empty entire buffer

4. IF NOT FULL AND S is fully watched THEN
a. Append ALL segments of S
b. Append first segment of M
c. Seek to start of first M segment
d. M continues to play

5. ELSE
a. Append first segment of S
b. Flag the fact that M should follow S
c. S continues to play
d. As playhead approaches end of S, append first segment of M
e. M continues to play

Type Z for transition 9 (FULL to L) or 11 (M to L) is more complicated and utilizes the following general format:

1. IF previous transition was Type Z AND S is NOT fully watched
a. Update flag specifying that L should follow S
b. GOTO 5c
c. END

2. ELSE cut at current position

3. Empty entire buffer

4. IF NOT FULL AND S is fully watched THEN
a. Append ALL segments of S
b. Append first segment of L
c. Seek to start of first L segment
d. L continues to play

5. ELSE
a. Append first segment of S
b. Flag the fact that L should follow S
c. S continues to play
d. As playhead approaches end of S, append first segment of L
e. L continues to play

According to an embodiment, this technique may be scaled by inserting additional timeframes between S and FULL.

Dynamic Allocation Transitions

According to an embodiment, a technique with increased dynamism for transitioning between Timeframes is used in the case where the administrator wishes to grant the user finer grained control over Episode duration. In this case, the administrator highlights an arbitrary number of segments, assigning a variable set of priorities to each of them using the Backend Video Editor. Timeframes are then built at runtime within the front-end player based on collections of individual segments. The user is then allowed to select the duration of the Episode through a set of commands provided by the player, which is able to request individual segments and concatenate them together at runtime.

The core functionality of the algorithm is in the selection and ordering of those segments based on the requested duration. For example, if the user wants to watch 1 minute of footage from an Episode with a FULL duration of 5 minutes, we need to compile a playlist of segments resulting in a total duration as close to 1 minute as possible by selecting those segments with the greatest importance/relevance whilst attempting to maintain narrative structure.

A single Episode may consist of any one of the following combinations of timeframes:
FULL
SMALL, FULL
SMALL, n, FULL
SMALL, n, . . . , FULL

The dynamic aspect comes in to play when looking at the number of timeframes between SMALL and FULL.

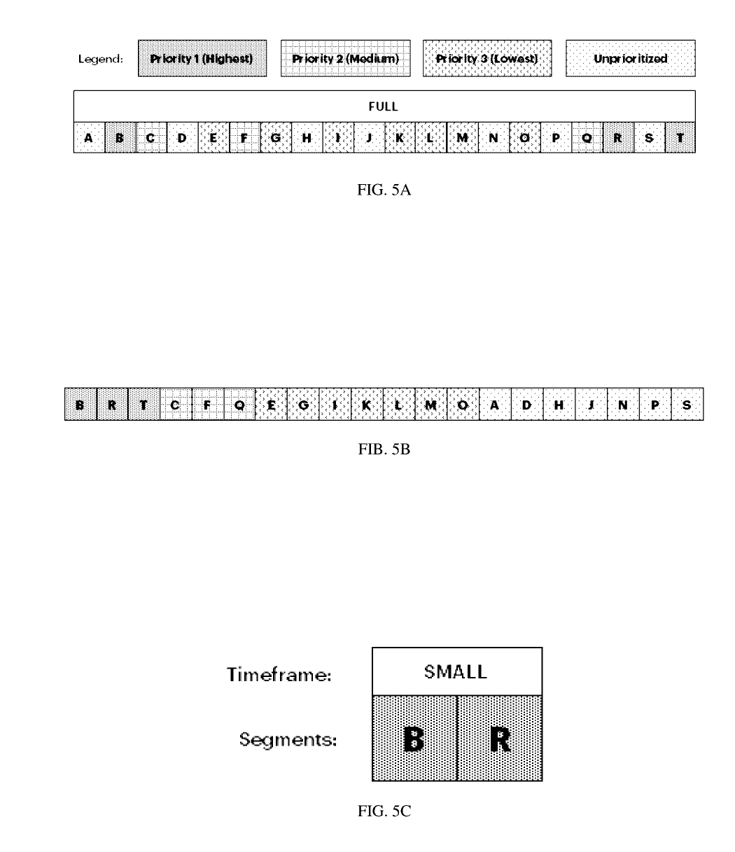

The following is an example of a timeline representing linear footage at FULL length. It has been segmented into subsections based on priority/importance/relevance (more information on Segment Prioritization can be found above), as shown in FIG. 5A. This example uses three priorities. For the purposes of this example, the length of each segment appears to be equal, in actuality this is unlikely to be the case.

The Selection and Sort Algorithm—Compiling the Priority Stack

Throughout this process, segments will be selected in order of their marked priority, then timecode. Sorting all segments on this basis would produce what is known as the ‘Priority Stack’, in the example it would look like the stack in FIG. 5B.

The selection and Sort Algorithm—Compiling the SMALL Timeframe

The player will first attempt to play a SMALL Timeframe. The length of SMALL may vary but for the purposes of this example, let's assume its target duration is 10-15 seconds. The compilation of a Timeframe is handled at runtime by the player according to the following steps:

1. Insert the first segment from the beginning of the Priority Stack (Segment B) into the playlist.

2. If the playlist containing inserted footage has a duration of less than 10 seconds, evaluate the resulting duration of the playlist if the next segment from the Priority Stack (Segment R) were to be inserted.
a. If the resulting playlist duration is closer to the 10-15 second target than the current playlist duration, commit to the insertion of Segment R.
b. If the resulting playlist duration takes us too far away from our target of 10-15 second, consider the footage already in the playlist as the entirety of our SMALL Timeframe.

3. Repeat Step 2 with further segments from the Priority Stack until Step 2.b is satisfied.

4. When Step 2.b is satisfied, ensure that the segments within the SMALL Timeframe are ordered by their master timecode (ie. segments of the same priority aren't necessarily contiguous).

The diagram in FIG. 5C represents the SMALL Timeframe. In our example, Segment T was not inserted, as segments B and R satisfied the 10-15 second target duration requirement. Note that from here onwards, regardless of any additional segments being inserted into the playlist by subsequent processes, the ordering of segments in the SMALL Timeframe is immutable.

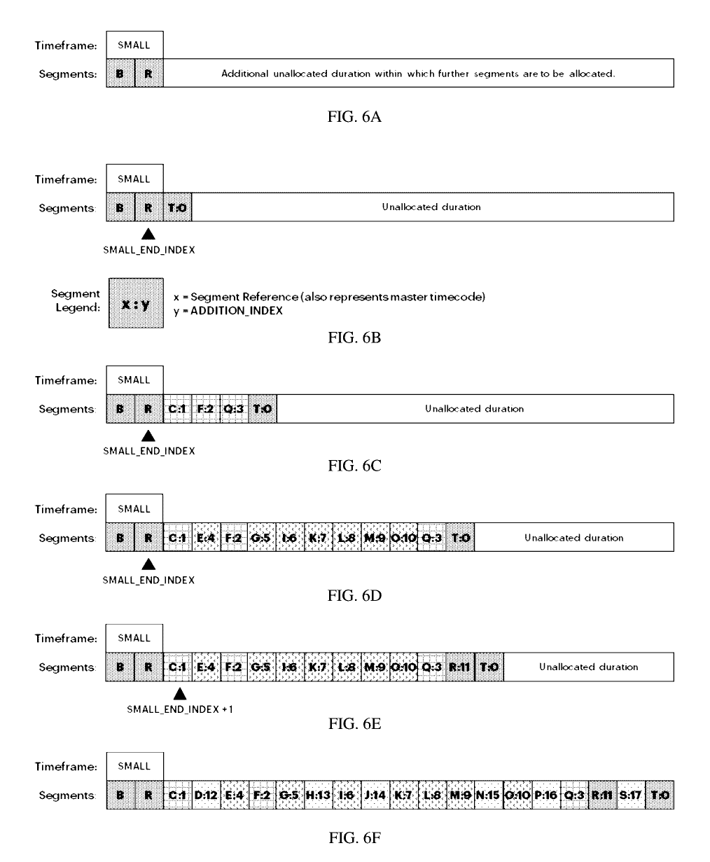

Without user interaction, or signaling from the recommendation engine, once the SMALL Timeframe playlist has completed playback, the player will move on to the next Episode as scheduled in the Channel. Alternatively, if the user or recommendation engine signals for the playlist duration to be increased, the system will need to determine the order in which segments will be added (or subsequently reversed to determine order of removal). Accordingly, the example proceeds to a state as illustrated in FIG. 6A in which subsequent segments must be compiled beyond the SMALL Timeframe.

Compiling Subsequent Segments Beyond the SMALL Timeframe

Treating the playlist as a zero-indexed array, the Timeframe compilation is made according to the following steps.

Step 1—Flag the index at which the system has ceased to append SMALL Timeframe segments: “SMALL_END_INDEX”. In this case, SMALL_END_INDEX would equal 1.

Step 2—Continue to insert additional segments from the Priority Stack into the playlist in ascending timecode order. Step 2.a—Assign a numeric value to track the order in which the segment was added: “ADDITION_INDEX”. The first segment to be added here will have an ADDITION_INDEX of 0. Step 2.b—The timecode sorting now only applies to the segments inserted beyond SMALL_END_INDEX as the ordering of segments in SMALL is immutable. Step 2.c—The diagram shown in FIG. 6B illustrates the playlist state having appended the remaining Priority 1 segment, Segment T.

Step 3—Continue to insert additional segments using the same technique as described in step 2. In this example, it's reached the point where the system has inserted all Priority 2 segments. Note how the ascending order of master timecode is preserved beyond SMALL_END INDEX, as shown in FIG. 6C.

Step 4—Continue to insert additional segments using the same technique as described in step 2. In this example, the example has reached the point where the system has inserted all Priority 3 segments, as shown in FIG. 6D.

Step 5—If the system has inserted all segments of the lowest defined priority, instead of immediately inserting unprioritized segments, segments already inserted within the SMALL Timeframe will be repeated beyond SMALL_END_INDEX, but only if their timecodes are greater than that of the segment at SMALL_END_INDEX+1. This would produce the result (note the repetition of Segment R, but not Segment B) shown in FIG. 6E.

Step 6—Next, the unprioritized segments (now the only segments on the Priority Stack that have not been inserted into the playlist) may be inserted beyond SMALL_END_INDEX, but only if their timecodes are greater than that of the segment at SMALL_END_INDEX+1. Note that in this example, Segment A was not eligible for playlist insertion and will only be viewable if the user requests FULL, as shown in FIG. 6F.

The system has now reached the maximum possible duration of an Episode compiled using the Dynamic Allocation algorithm. The duration may be:
less than FULL if there were any segments not eligible for playlist insertion (ie. Segment A in this example) and any repeated segments have a cumulative duration less than the cumulative duration of those segments not eligible.
equal to FULL if all segments were eligible for playlist insertion and SMALL Timeframe segments were not repeated beyond SMALL_END_INDEX. Or if any non-eligible segments have a cumulative duration equal to the cumulative duration of any repeated segments.
greater than FULL if all segments were eligible for playlist insertion and SMALL Timeframe segments were repeated beyond SMALL_END_INDEX. Or if any repeated segments have a cumulative duration greater than the cumulative duration of those segments not eligible.

The selection and Sort Algorithm—Applying Selection and Sort Beyond the SMALL Timeframe

When the playhead's position is greater than or equal to the beginning of the segment at SMALL_END_INDEX+1, changes to duration only affect segments that begin beyond the playhead position (except those immutable segments within the SMALL Timeframe).

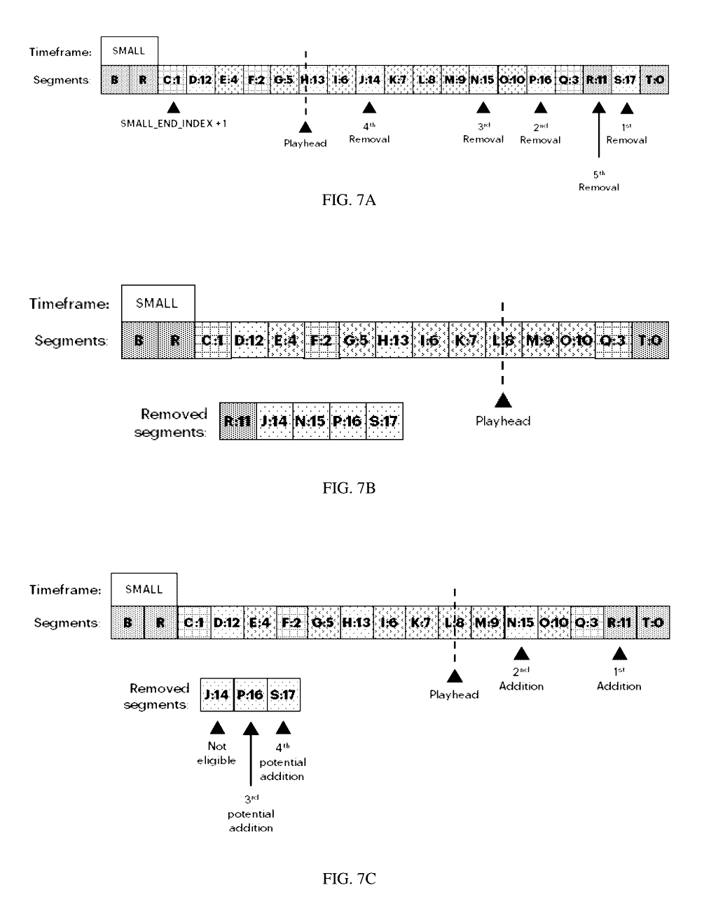

The following example is a continuation of those previous, where all segments have been added to the playlist. The playhead is now beyond the SMALL Timeframe and the user is about to request a decrease in duration. The Episode playlist duration may be decrementally reduced by the duration of each segment next in line for removal. The order of removal is determined by reversing the order in which segments were added to the playlist, that is the segment with the highest ADDITION_INDEX (with a playlist start time beyond the playhead position) will always be next in line for removal. The next five segments in line for removal are outlined in the diagram shown in FIG. 7A.

The diagram in FIG. 7B below illustrates the playlist state after those five segments have been removed. The playhead has also proceeded to move forward as the user has continued to watch the reduced duration. If the user were to increase the duration at this point, the system would source additional segments from any that had been previously removed. Segments would only be eligible for addition if their master timecode is greater than the start timecode+duration of the segment currently at the playhead position. The diagram in FIG. 7C shows the addition of two segments (N and R) as well as the order that further segments (P and S) would be added in if the playlist's duration were to be further increased at the current playhead position. If the playhead were moved backwards (via a user rewind/seek) to Segment I, the maximum potential duration of the playlist would increase, as Segment J would once again be eligible for addition.

Loading of Data

Segmentation at Byte-Level

In the case of Simple Transitions, each Timeframe has a video file associated to it. In the case of Dynamic Allocation Transitions, each priority segment has a video file associated. Its data is prepared in a fashion that individual sub-segments can be requested in individual HTTP requests ultimately allowing, for example, Adaptive Bitrate Streaming. Dependent on the requirements of a specific front-end player implementation, this may utilize the MPEG-DASH standard, Apple HTTP Adaptive Streaming (HLS), Adobe Dynamic Streaming (HDS), Microsoft Smooth Streaming, or any other method facilitating Adaptive Bitrate Streaming.

With the MPEG-DASH implementation as used in the browser, the player requests the file's segment index using an HTTP byte range request. It subsequently decides via browser-based logic which media segments should be loaded and when. The loaded segments are appended to a buffer shortly before playback. Our implementation differs from the typical MPEG-DASH implementation in that the player will concatenate bytes from a single source file (characterized by having its own segment index) together with bytes originating from a completely separate file (again, with its own segment index). This allows the player to continue seamless playback when procuring content from across multiple files.

Preloading

In order to provide an experience that is as seamless as possible, the player can preload segments in anticipation of playback. A small amount of data is preloaded into each timeframe of the current screen. If and when the user navigates to another timeframe, provided that the preload of the requested timeframe has completed, the player will not be obstructed by lack of data in order to commence playback when it sees fit to do so. A small amount of data is also preloaded into the initial timeframes of both adjacent screens. Providing preload has completed, the player may commence playback as soon as a navigational transition begins from one screen to another. If in any situation, the player attempts to begin playback but the required minimum amount of data has not yet preloaded, a buffering visual notification will be displayed until the required amount of data is available.

Organization Management of a Video Platform System

The video content system can be deployed as a Platform as a Service (“PaaS”), or as a platform installable to a custom public or private environment. According to an embodiment in which the system is deployed in a PaaS format, the system can include one or more servers and interfaces for providing functionality to users. According to an embodiment the video platform system, includes at least a backend platform for editing content.

According to an embodiment, for example, a user can sign up or enroll in the platform and either join or build an organization infrastructure. Joining an organization can be achieved in, for example, three or more ways: (1) issuing a request to an organization owner; (2) accepting a request coming from an organization owner; and/or (3) creating a new organization and becoming its owner, among other methods.

According to an embodiment, for example, a user can assume several roles within an organization. The owner has access to all organization details, platform billing plans and complete user management for roles assignment. The billing administrator has access to billing and invoicing details, can see breakdown of costs, historical data and projections. The network administrator can manage content networks, create/edit/delete channels, and manage assignments of editors to channels. The editor has access to a channel or a set of channels, can upload content, define timeframes, annotations and publishing status of content related to channels where he/she has access.

API Based Service

All services provided by the platform could also be available via an API, thus making it possible to implement third-party applications relying on the whole set or a subset of functions.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

A “module” or “component” as may be used herein, can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

What is claimed is:

1. A system for creating and delivering a customized video based upon a video stock of predetermined duration, comprising:
a. a server computer having a first computer processor;
b. a back-end computer program product for use by an administrator to create the customized video, the back-end computer program product comprising computer readable storage medium having program instructions embodied therewith, the program instructions executable by said first computer processor to cause the computer processor to prioritize at least two distinct segments from the video stock in order to create at least two different durations of the video stock each of which is shorter in duration than the predetermined duration;
c. at least one end user device having a second computer processor and in operative communication with said server computer; and
d. a front-end computer program product for use by an end user to consume the customized video, the front-end computer program product comprising computer readable storage medium having program instructions embodied therewith, the program instructions executable by said second computer processor to cause the device to permit the end user to select which of the at least two distinct video segments to execute on the device.

2. The system according to claim 1, wherein said program instructions of said back-end computer program are executable by said first computer processor to cause the computer processor to:
a. assign a first priority to at least one distinct segment from the video stock in order to create at least one first priority segment of at least one different duration of the video stock which is shorter in duration than the predetermined duration;
b. assign a second priority to at least one distinct segment from the video stock in order to create at least one second priority segment of at least one different duration of the video stock which is shorter in duration than the predetermined duration; and
c. arrange the customized video such that each of the first priority segments is played prior to the second priority segments.

3. The system according to claim 2, wherein said program instructions executable by a computer processor cause the computer processor to permit creation of a plurality of customized videos each one of which comprises a plurality of timeframes, wherein each of said timeframes comprise an edited version of one of said plurality of customized versions with a specific duration.

4. The system according to claim 3, wherein said program instructions executable by a computer processor cause the computer processor to link each of said plurality of customized videos to others of said plurality of customized videos.

5. The system according to claim 3, wherein said program instructions executable by a computer processor cause the computer processor to create a plurality of channels each one of which comprises a plurality of customized videos.

6. The system according to claim 5, wherein said program instructions executable by a computer processor cause the computer processor to link each of said customized videos to at least one channel.

7. The system according to claim 5, wherein said program instructions executable by a computer processor cause the computer processor to display of any of the plurality of customized videos according to predetermined scheduling rules.

8. The system according to claim 1, wherein said program instructions of said front-end computer program are executable by said second computer processor to cause the second computer processor to:
a. provide a user interface that permits the end user to select from a plurality of options for viewing the customized video, wherein said plurality of options comprises customized video segments each of which is at least a portion of said customized video and of a respective second predetermined duration that is no longer than said first predetermined duration; and
b. display the end user selected video segment.

9. The system according to claim 8, wherein said user interface comprises presenting the end user with a plurality of custom video selections each of which is of different duration.

10. The system according to claim 9, wherein said user interface defaults to one of said plurality of custom video selections.

11. The system according to claim 9, wherein said user interface requires end user selection of one of the plurality of custom vide selections.

12. The system according to claim 9, wherein said plurality of custom video selections comprise short duration, medium duration, long duration, and full length duration segments of said custom video.

13. A computer program product for use by an administrator to create customized video from a stock video of predetermined duration, the computer program product comprising computer readable storage medium having program instructions embodied therewith, the program instructions executable by a computer processor to cause the computer processor to:
a. assign a first priority to at least one distinct segment from the video stock in order to create at least one first priority segment of at least one different duration of the video stock which is shorter in duration than the predetermined duration;
b. assign a second priority to at least one distinct segment from the video stock in order to create at least one second priority segment of at least one different duration of the video stock which is shorter in duration than the predetermined duration; and
c. arrange the customized video such that each of the first priority segments is played prior to the second priority segments.

14. The computer program according to claim 13, wherein said program instructions executable by a computer processor cause the computer processor to permit creation of a plurality of customized videos each one of which comprises a plurality of timeframes, wherein each of said timeframes comprise an edited version of one of said plurality of customized versions with a specific duration.

15. The computer program according to claim 14, wherein said program instructions executable by a computer processor cause the computer processor to link each of said plurality of customized videos to others of said plurality of customized videos.

16. The computer program according to claim 15, wherein said program instructions executable by a computer processor cause the computer processor to create a plurality of channels each one of which comprises a plurality of customized videos.

17. The computer program according to claim 16, wherein said program instructions executable by a computer processor cause the computer processor to link each of said customized videos to at least one channel.

18. The computer program according to claim 16, wherein said program instructions executable by a computer processor cause the computer processor to display of any of the plurality of customized videos according to predetermined scheduling rules.

19. A method for creating customized video from a stock video of predetermined duration, comprising the steps of:
a. assigning a first priority to at least one distinct segment from the video stock in order to create at least one first priority segment of at least one different duration of the video stock which is shorter in duration than the predetermined duration;
b. assigning a second priority to at least one distinct segment from the video stock in order to create at least one second priority segment of at least one different duration of the video stock which is shorter in duration than the predetermined duration; and
c. arranging the customized video such that each of the first priority segments is played prior to the second priority segments.

20. A computer program product for use on a device having a computer processer by an end user to consume a customized video created from a stock video of first predetermined duration, the computer program product comprising computer readable storage medium having program instructions embodied therewith, the program instructions executable by the computer processor to cause the device to:
a. provide a user interface that permits the end user to select from a plurality of options for viewing the customized video, wherein said plurality of options comprises customized video segments each of which is at least a portion of said customized video and of a respective second predetermined duration that is no longer than said first predetermined duration; and
b. display the end user selected video segment.

21. The computer program product according to claim 20, wherein said user interface comprises presenting the end user with a plurality of custom video selections each of which is of different duration.

22. The computer program product according to claim 21, wherein said user interface defaults to one of said plurality of custom video selections.

23. The computer program product according to claim 21, wherein said user interface requires end user selection of one of the plurality of custom vide selections.

24. The system according to claim 21, wherein said plurality of custom video selections comprise short duration, medium duration, long duration, and full length duration segments of said custom video.
